(19) United States
(12) Patent Application Publication
(10) Pub. No.: US 2024/0362681 A1
(43) Pub. Date: Oct. 31, 2024

(54) Real Time Mobile Vehicle Coupled Electronic Advertisement Message System and Method

(71) Applicant: IEM America Corporation, Auburn, WA (US)

(72) Inventors: Satyajit Chakrabarti, Auburn, WA (US); Amartya Mukherjee, Kolkata (IN); Ayan Kumar Panja, Kolkata (IN); Souvik Chatterjee, Howrah (IN)

(73) Assignee: IEM America Corporation, Auburn, WA (US)

(21) Appl. No.: 18/769,467

(22) Filed: Jul. 11, 2024

(30) Foreign Application Priority Data
Aug. 3, 2022 (IN) 202231044342

(51) Int. Cl. G06Q 30/0251; B60R 13/00; B61D 49/00

(52) U.S. Cl. CPC G06Q 30/0265; B60R 13/00; B61D 49/00

(57) ABSTRACT

Systems and methods are provided for electronic real time advertisement message emission electronically emitted by one or more mobile vehicle coupled electronic advertisement message emitters according to reception of at least one order for at least one advertisement message emission based on real time electronically receiving availability and location status data along with advertisement message emission orders, real time determining advertisement messages to be emitted, real time determining electronic advertisement message emitters, and real time electronically transmitting advertisement messages to destination mobile vehicles to be emitted by the determined electronic advertisement message emitter coupled with the destination mobile vehicles.

### SUMMARY

In implementations a computer implemented method provides electronic real time advertisement message emission electronically emitted by one or more mobile vehicle coupled electronic advertisement message emitters according to reception of at least one order for at least one advertisement message emission, the computer implemented method includes real time electronically receiving availability and location status data regarding at least one electronic advertisement message emitter being coupled with at least one mobile vehicle; electronically receiving at least one advertisement message emission order for at least one advertisement message emission to be emitted by at least one electronic advertisement message emitter being coupled with at least one mobile vehicle; real time determining at least one determined advertisement message to be emitted by at least one electronic advertisement message emitter coupled with at least one mobile vehicle based at least in part on the at least one advertisement message emission order; real time determining at least one determined electronic advertisement message emitter coupled with at least one destination mobile vehicle to emit the at least one determined advertisement message based at least in part on the availability and location status data regarding the at least one determined electronic advertisement message emitter being coupled with at least one mobile vehicle; and real time electronically transmitting the at least one advertisement message to the at least one destination mobile vehicle to be emitted by the determined electronic advertisement message emitter coupled with the at least one destination mobile vehicle. Implementations further include real time electronically determining at least one determined geographical region for advertisement message emission associated with the at least one advertisement message emission order based at least in part on the at least one advertisement message emission order; and real time electronically determining the at least one determined electronic advertisement message emitter coupled with the at least one destination mobile vehicle to emit the at least one determined advertisement message based at least in part on the at least one determined geographical region for advertisement message emission. Implementations further include real time electronically determining at least one determined emitter type associated with the at least one determined electronic advertisement message emitter based at least in part on the at least one advertisement message emission order; and real time electronically determining the at least one determined electronic advertisement message emitter coupled with the at least one destination mobile vehicle to emit the at least one determined advertisement message based at least in part on the at least one determined emitter type associated with the at least one determined electronic advertisement message emitter. Implementations further include real time electronically receiving passenger status data from the at least one destination mobile vehicle; and real time electronically determining advertising costs associated with the at least one advertisement message emission order based at least upon the passenger status data received from the at least one destination mobile vehicle. In implementations the at least one determined electronic advertisement message emitter comprises at least one device selected from the group consisting of at least one electronic audio speaker, at least one electronic video display, at least one electronic alphanumeric text display, and at least one electronic audio video speaker display combination. In implementations the at least one determined electronic advertisement message emitter comprises at least one emitter selected from a group including but not limited to: at least one emitter coupled to at least one subway vehicle exterior, at least one emitter coupled to at least one commuter train vehicle exterior, at least one emitter coupled to at least one bus vehicle exterior, at least one emitter coupled to at least one automobile vehicle exterior, at least one emitter coupled to at least one van vehicle exterior, and at least one emitter coupled to at least one truck vehicle exterior. In implementations the at least one determined electronic advertisement message emitter comprises at least one emitter selected from a group including but not limited to: at least one emitter coupled to at least one subway vehicle interior, at least one emitter coupled to at least one commuter train vehicle interior, at least one emitter coupled to at least one bus vehicle interior, at least one emitter coupled to at least one automobile vehicle interior, at least one emitter coupled to at least one van vehicle interior, and at least one emitter coupled to at least one truck vehicle interior.

In implementations a real time electronic advertisement message emission system for providing real time electronic advertisement message emission electronically emitted by one or more mobile vehicle coupled electronic advertisement message emitters according to reception of at least one order for at least one advertisement message emission, the real time electronic advertisement message emission system including at least one memory; and at least one processor configured for: real time electronically receiving availability and location status data regarding at least one electronic advertisement message emitter being coupled with at least one mobile vehicle; electronically receiving at least one advertisement message emission order for at least one advertisement message emission to be emitted by at least one electronic advertisement message emitter being coupled with at least one mobile vehicle; real time determining at least one determined advertisement message to be emitted by at least one electronic advertisement message emitter coupled with at least one mobile vehicle based at least in part on the at least one advertisement message emission order; real time determining at least one determined electronic advertisement message emitter coupled with at least one destination mobile vehicle to emit the at least one determined advertisement message based at least in part on the availability and location status data regarding the at least one determined electronic advertisement message emitter being coupled with at least one mobile vehicle; and real time electronically transmitting the at least one advertisement message to the at least one destination mobile vehicle to be emitted by the determined electronic advertisement message emitter coupled with the at least one destination mobile vehicle. In implementations the at least one processor is further configured to real time electronically determining at least one determined geographical region for advertisement message emission associated with the at least one advertisement message emission order based at least in part on the at least one advertisement message emission order; and real time electronically determining the at least one determined electronic advertisement message emitter coupled with the at least one destination mobile vehicle to emit the at least one determined advertisement message based at least in part on the at least one determined geographical region for advertisement message emission. In implementations the at least one processor is further configured to real time electronically determining at least one determined emitter type associated with the at least one determined electronic advertisement message emitter based at least in part on the at least one advertisement message emission order; and real time electronically determining the at least one determined electronic advertisement message emitter coupled with the at least one destination mobile vehicle to emit the at least one determined advertisement message based at least in part on the at least one determined emitter type associated with the at least one determined electronic advertisement message emitter. In implementations the at least one processor is further configured to real time electronically receiving passenger status data from the at least one destination mobile vehicle; and real time electronically determining advertising costs associated with the at least one advertisement message emission order based at least upon the passenger status data received from the at least one destination mobile vehicle. In implementations the at least one determined electronic advertisement message emitter comprises at least one device selected from a group including but not limited to at least one electronic audio speaker, at least one electronic video display, at least one electronic alphanumeric text display, and at least one electronic audio video speaker display combination. In implementations the at least one determined electronic advertisement message emitter comprises at least one emitter selected from a group including but not limited to at least one emitter coupled to at least one subway vehicle, at least one emitter coupled to at least one commuter train vehicle, at least one emitter coupled to at least one bus vehicle, at least one emitter coupled to at least one automobile vehicle, at least one emitter coupled to at least one van vehicle, and at least one emitter coupled to at least one truck vehicle.

In implementations a non transitory computer readable medium includes instructions for use on one or more electronic computing devices, the instructions being usable to execute a method of providing real time electronic advertisement message emission electronically emitted by one or more mobile vehicle coupled electronic advertisement message emitters according to reception of at least one order for at least one advertisement message emission. In implementations the method includes A non transitory computer readable medium comprising instruction for use on one or more electronic computing devices, the instructions being usable to execute a method of providing real time electronic advertisement message emission electronically emitted by one or more mobile vehicle coupled electronic advertisement message emitters according to reception of at least one order for at least one advertisement message emission, the method includes real time electronically receiving equipment status monitoring sensor data from a plurality of electronic sensors based on one or more data types selected from a plurality of data types including but not limited to temperature data, magnetic flux data, vibration data, and ultrasound data; real time electronically filtering of the equipment status monitoring sensor data to produce filtered equipment status monitoring sensor data with reduced noise content; real time electronically determining at least in part one or more equipment status information based on one or more aspects of the filtered equipment status monitoring sensor data, wherein the equipment status information includes one or more selections from a list including but not limited to one or more equipment status indicators, the equipment status monitoring sensor data, and the filtered equipment status monitoring sensor data, and one or more display instructions for use by the at least one subscriber based electronic user interface client application; and real time electronically transmitting equipment status information to the at least one subscriber based electronic user interface client application based on at least one subscriber status associated with the at least one subscriber based electronic user interface client application. In implementations the method includes real time electronically determining at least one determined geographical region for advertisement message emission associated with the at least one advertisement message emission order based at least in part on the at least one advertisement message emission order; and real time electronically determining the at least one determined electronic advertisement message emitter coupled with the at least one destination mobile vehicle to emit the at least one determined advertisement message based at least in part on the at least one determined geographical region for advertisement message emission. In implementations the method includes real time electronically determining at least one determined emitter type associated with the at least one determined electronic advertisement message emitter based at least in part on the at least one advertisement message emission order; and real time electronically determining the at least one determined electronic advertisement message emitter coupled with the at least one destination mobile vehicle to emit the at least one determined advertisement message based at least in part on the at least one determined emitter type associated with the at least one determined electronic advertisement message emitter. In implementations the method includes real time electronically receiving passenger status data from the at least one destination mobile vehicle; and real time electronically determining advertising costs associated with the at least one advertisement message emission order based at least upon the passenger status data received from the at least one destination mobile vehicle. In implementations the method includes the at least one determined electronic advertisement message emitter includes at least one device selected from the group consisting of at least one electronic audio speaker, at least one electronic video display, at least one electronic alphanumeric text display, and at least one electronic audio video speaker display combination. In implementations the method includes the at least one determined electronic advertisement message emitter includes at least one emitter selected from the group consisting of: at least one emitter coupled to at least one subway vehicle exterior, at least one emitter coupled to at least one commuter train vehicle exterior, at least one emitter coupled to at least one bus vehicle exterior, at least one emitter coupled to at least one automobile vehicle exterior, at least one emitter coupled to at least one van vehicle exterior, and at least one emitter coupled to at least one truck vehicle exterior. In implementations the method includes the at least one determined electronic advertisement message emitter includes at least one emitter selected from the group consisting of: at least one emitter coupled to at least one subway vehicle interior, at least one emitter coupled to at least one commuter train vehicle interior, at least one emitter coupled to at least one bus vehicle interior, at least one emitter coupled to at least one automobile vehicle interior, at least one emitter coupled to at least one van vehicle interior, and at least one emitter coupled to at least one truck vehicle interior.

In addition to the foregoing, other aspects are described in the claims, drawings, and text forming a part of the disclosure set forth herein. Various other aspects are set forth and described in the teachings such as text (e.g., claims and/or detailed description) and/or drawings of the present disclosure. The foregoing is a summary and thus may contain simplifications, generalizations, inclusions, or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is a representative conceptual schematic diagram of a real time vehicle coupled advertisement system.

FIG. 2 is a representative flow diagram associated with aspects of the real time vehicle coupled advertisement system of FIG. 1.

FIG. 3 is a representative flow diagram associated with additional aspects of the real time vehicle coupled advertisement system of FIG. 1.

FIG. 4 is a representative flow diagram associated with additional aspects of the real time vehicle coupled advertisement system of FIG. 1.

FIG. 5 is a representative flow diagram associated with additional aspects of the real time vehicle coupled advertisement system of FIG. 1.

FIG. 6 is a representative flow diagram associated with aspects of a first portion of the representative flow diagram of FIG. 2.

FIG. 7 is a representative flow diagram associated with aspects of a second portion of the representative flow diagram of FIG. 2.

FIG. 8 is a representative flow diagram associated with aspects of a third portion of the representative flow diagram of FIG. 2.

FIG. 9 is a representative flow diagram associated with aspects of a fourth portion of the representative flow diagram of FIG. 2.

FIG. 10 is a representative flow diagram associated with aspects of a fifth portion of the representative flow diagram of FIG. 2.

FIG. 11 is a representative flow diagram associated with aspects of a first portion of the representative flow diagram of FIG. 3.

FIG. 12 is a representative flow diagram associated with aspects of a second portion of the representative flow diagram of FIG. 3.

FIG. 13 is a representative flow diagram associated with aspects of a first portion of the representative flow diagram of FIG. 4.

FIG. 14 is a representative flow diagram associated with aspects of a second portion of the representative flow diagram of FIG. 4.

FIG. 15 is a representative flow diagram associated with aspects of a first portion of the representative flow diagram of FIG. 5.

FIG. 16 is a representative flow diagram associated with aspects of a second portion of the representative flow diagram of FIG. 5.

For a more complete understanding of implementations, reference now is made to the following descriptions taken in connection with the accompanying drawings. The use of the same symbols in different drawings typically indicates similar or identical items, unless context dictates otherwise.

With reference now to the figures, shown are one or more examples of Real Time Mobile Vehicle Coupled Electronic Advertisement Message System and Method, articles of manufacture, compositions of matter for same that may provide context, for instance, in introducing one or more processes and/or devices described herein.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here.

The term, computer readable medium, does not include “transitory waves or signals.” As used herein, the terms “include” and “comprise” are used synonymously, which terms and variants thereof are intended to be construed as non-limiting. Furthermore, the term, “real time,” is used as commonly defined by The American Heritage® Dictionary of the English Language, 5th Edition to be “[t]he time required for a computer to solve a problem, measured from the time data are fed in to the time a solution is received” and as commonly defined by the Cambridge Dictionary to be “the very short amount of time needed for computer systems to receive data and information and then communicate it or make it available.”

Throughout various portions of the following description, implementations are described in the context of application to mobile vehicle platforms for electronic emissive publication of various advertisements involving global positioning system coordination along with wireless communication systems in virtualized forms integrated with a cloud interface architecture for such publication in a real time context. However, as will be understood by one skilled in the art after reviewing this disclosure, various implementations of the present disclosure may have a wide variety of applications in other contexts not expressly enumerated, such as, for example, other device architectures, groupings of devices, protocols, networks, computer configurations, etc. being used for such real time operations. Various implementations of the present disclosure are described in the context of the above described layered levels regarding device, computer and software application usable for collecting, analyzing, storing, publishing, emitting, etc. However, for each of the features described, it is contemplated that in some embodiments, these aspects can also be provided in other configurations to achieve similar goals of real time mobile vehicle coupled electronic advertisement messaging as an original component of the communications software, rather than a modification or supplementation.

Implementations include network virtualization, LTE, 4G, 4G+, 5G, 6G, Wifi, (DSRC (dedicated short-range communications (IEEE 802.11p)), etc., advertisement provisioning and cloud infrastructure. Implementations include provisioning targeted advertisements pertaining to selected regions through query mechanism. Implementations include deploying location aware dynamic advertisements through vehicular infrastructure integrated wireless network infrastructure (e.g. 4G/5G, IEEE 802.11, etc.).

Implementations include connected vehicle architectures such as those involved with smart city concepts. Implementations include commercial applications including those associated with private businesses, enterprise businesses, etc. Implementation adopt vehicular advertisement associated with vehicular location awareness. Implementations leverage positional and communication technologies to maintain connection between moving vehicles and advertisement servers. Implementations utilize a layered architecture in general and a three-layer architecture in particular.

Implementations utilize a first layer associated with varied vehicular unit types such as commercial and private vehicles with coupled display units which include visual and audio emitters for output of ad content. Implementations include associated devices including data buffers, wireless 4G/Wi-Fi networking modules, GPS enabled devices for location tracking. Implementations provide location-aware advertisement services incorporating tracking with location realization. Implementations incorporate extended processing and query generation. Implementations include communication units utilizing 4G/5G, etc. networking or Wi-Fi networking.

Implementations utilize a second layer generally including a networking backbone, which can involve such as LTE, IEEE 802.11, DSRC, etc. networking technologies. Implementations utilize LTE backbone architecture including controller and database service for control and resolving vehicle transmitted query information. Implementations utilize TCP/UDP or DSRC protocol stacks to perform short-range communication. Implementations include interoperability between various protocol stacks with software-defined networking. Second layer implementations include network virtualization such as by network slicing mechanisms also known as network function virtualization.

Implementations utilize a third layer utilizes one or more cloud frameworks such as based on service (PaaS) feature platforming. Implementations of this third layer include components such as publisher advertising services, advertiser advertisement services, and query processor units. Implementations of the advertiser advertisement services provide vendor functions for business owner created advertisements. Implementations of the publisher advertisement services serve one or more brokers for one or more advertisement services to provide decisions based on query generator output. Implementations of the query processor processes one or more queries generated by one or more query generator units found on various one or more mobile vehicles of interest, which are based on mobile vehicle location(s) found in the one or more queries where upon advertisement message(s) are selected or generated from advertiser advertisement services and redirected to publisher advertising services. Implementations of publisher advertisement services broadcast advertisement messages through available network infrastructures with one or more tokens generated by implementations of the publisher advertisement server for one or more specific locations. Implementations include one or more mobile vehicles that are available within one or more determined locations receiving advertisement information and filters based on received one or more tokens. In implementations advertisements contain legitimate tokens are streamed and executed in appropriate mobile vehicles.

Implementations locate advertisement message emitters (e.g. video displays, alphanumeric displays, audio speakers, a combination thereof, etc.) coupled to mobile vehicle interiors or mobile vehicle interiors or both. Implementations of interior placement can include public transports like buses, taxis and cabs. Interior placed emitters such as display units can be placed inside of buses along with route display boards or inside of taxi, cab, uber, etc. placed in front of passenger seat(s). Implementations of exterior placement can include emitters such as displays placed on rooftops of automobiles, taxis, cabs, Ubers, etc. or placed on side, rear, or front surfaces such of buses, trains, trucks, vans, commuter or subway cars, etc. also having availability near or adjacent to windows or windshields.

Implementations can determine advertisement message costs based on a pay-per-mile (PPM), which utilizes counts of number of impressions received for particular advertisement emissions, such as being displayed to passengers or those outside of mobile vehicles. For example, in a particular instance of time the primary parameter to be considered are the GPS location, time (t), p and the vehicle[i], where p is the payment parameter, vehicle[v] is the vth vehicle instance eligible for the payment. At the initial case the GPS coordinate is fetched for the vehicle and by fetching the latitude, longitude information. A specific geofence has been made by considering at a radius r. Here r can be set based on the transmission range of the vehicle. The area A=π*r² is considered as region of interest for advertisement. Now the computation has to be done based on count of the passenger inside Iᵥ and the pedestrian outside Oᵥ who are seeing the advertisement. A sensing mechanism can be implemented for count the number of passengers inside the vehicle by using seat occupancy sensing. Therefore, the total count p=Iᵥ+Oᵥ. Now the Query has been set towards query processor for the query generator based on the parameter location, p can be represented as Q(GPS,p). the payment on the other hand gets received as a function F such that F(i,GPS,p,t) belongs to vehicle[i].

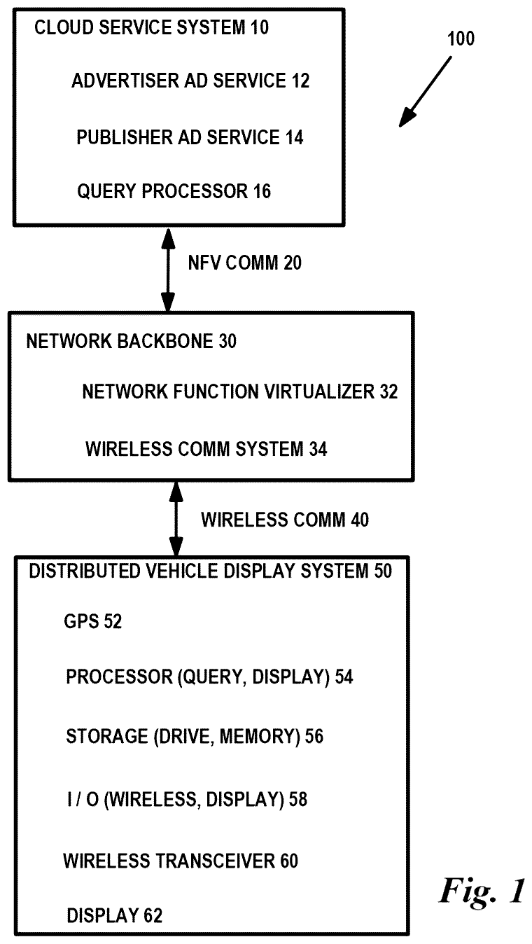

Turning to FIG. 1, depicted therein is a representative implementation as a conceptual schematic diagram of real time mobile vehicle coupled electronic advertisement message system 100 including cloud service system 10 with advertiser advertisement service 12, publisher advertisement service 14, and query processor 16; network backbone 30 with network function virtualizer 32, and wireless communication system 34; and distributed vehicle display system 50 with global position system (GPS) 52, processor (including processing query portion and display portion) 54, storage (including drive and memory) 56, input/output (including wireless and display), wireless transceiver 60, and display 62. Further depicted is network function virtualization (NFV) communication 20 between cloud service system 10 and network backbone 30; and wireless communication 40 such as LTE, 4G, 4G+, 5G, 6G, Wifi, (DSRC (IEEE 802.11p)), etc. between network backbone 30 and distributed vehicle display system 50.

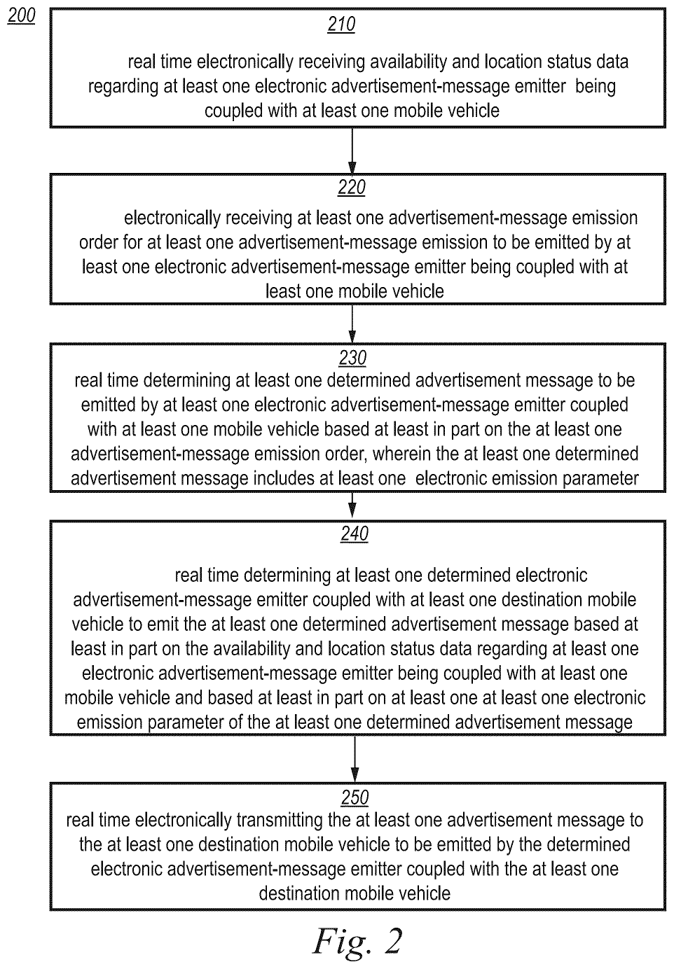

Turning to FIG. 2, depicted therein is a representative flow diagram associated with aspects of the real time vehicle coupled advertisement system 100 involving method 200 of providing electronic real time advertisement message emission electronically emitted by one or more mobile vehicle coupled electronic advertisement message emitters according to reception of at least one order for at least one advertisement message emission including step 210, step 220, step 230, step 240, and step 250. Step 210 includes real time electronically receiving availability and location status data regarding at least one electronic advertisement-message emitter being coupled with at least one mobile vehicle. Step 220 includes electronically receiving at least one advertisement-message emission order for at least one advertisement-message emission to be emitted by at least one electronic advertisement-message emitter being coupled with at least one mobile vehicle. Step 230 includes real time determining at least one determined advertisement message to be emitted by at least one electronic advertisement-message emitter coupled with at least one mobile vehicle based at least in part on the at least one advertisement-message emission order, wherein the at least one determined advertisement message includes at least one electronic emission parameter. Step 240 includes real time determining at least one determined electronic advertisement-message emitter coupled with at least one destination mobile vehicle to emit the at least one determined advertisement message based at least in part on the availability and location status data regarding at least one electronic advertisement-message emitter being coupled with at least one mobile vehicle and based at least in part on at least one at least one electronic emission parameter of the at least one determined advertisement message. Step 250 includes real time electronically transmitting the at least one advertisement message to the at least one destination mobile vehicle to be emitted by the determined electronic advertisement-message emitter coupled with the at least one destination mobile vehicle.

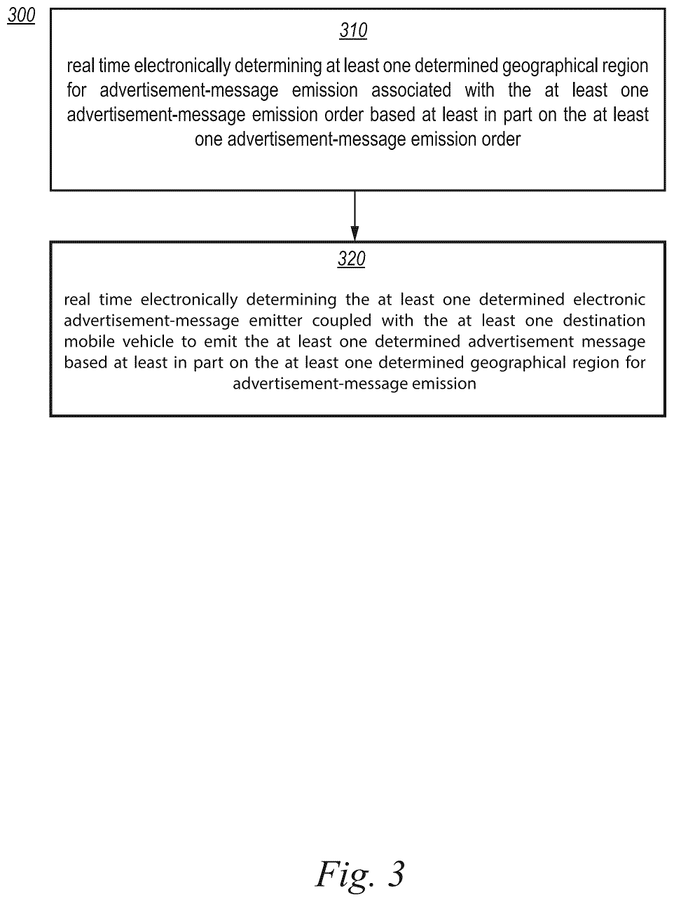

Turning to FIG. 3, depicted therein is a representative flow diagram associated with additional aspects of the real time vehicle coupled advertisement system 100 involving method 200 further including step 310 and step 320. Step 310 includes real time electronically determining at least one determined geographical region for advertisement-message emission associated with the at least one advertisement-message emission order based at least in part on the at least one advertisement-message emission order. Step 320 includes real time electronically determining the at least one determined electronic advertisement-message emitter coupled with the at least one destination mobile vehicle to emit the at least one determined advertisement message based at least in part on the at least one determined geographical region for advertisement-message emission.

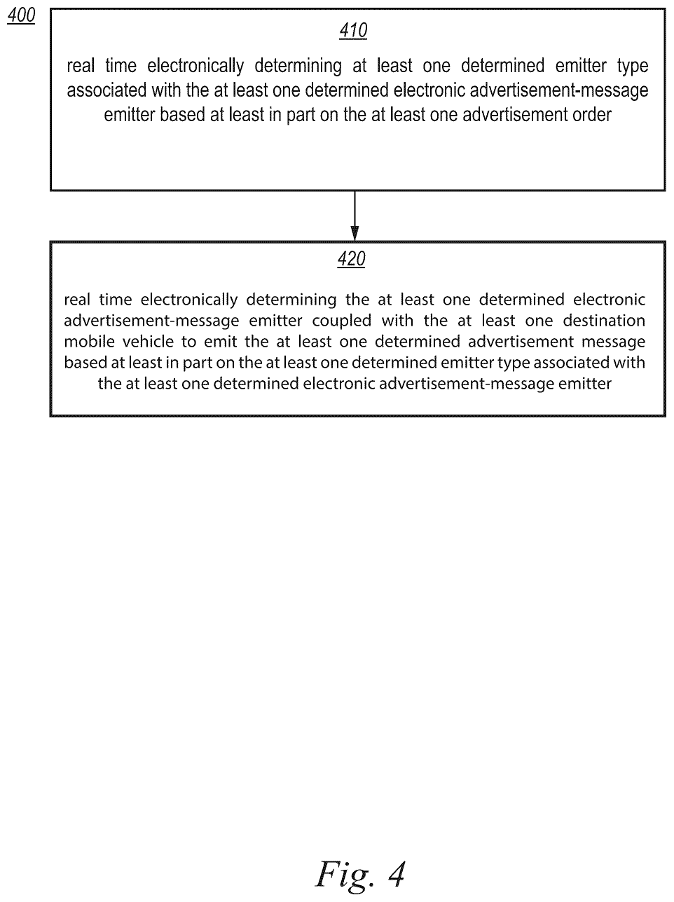

Turning to FIG. 4, depicted therein is a representative flow diagram associated with additional aspects of the real time vehicle coupled advertisement system 100 involving method 200 further including step 410 and step 420. Step 410 includes real time electronically determining at least one determined emitter type associated with the at least one determined electronic advertisement-message emitter based at least in part on the at least one advertisement order. Step 420 includes real time electronically determining the at least one determined electronic advertisement-message emitter coupled with the at least one destination mobile vehicle to emit the at least one determined advertisement message based at least in part on the at least one determined emitter type associated with the at least one determined electronic advertisement-message emitter.

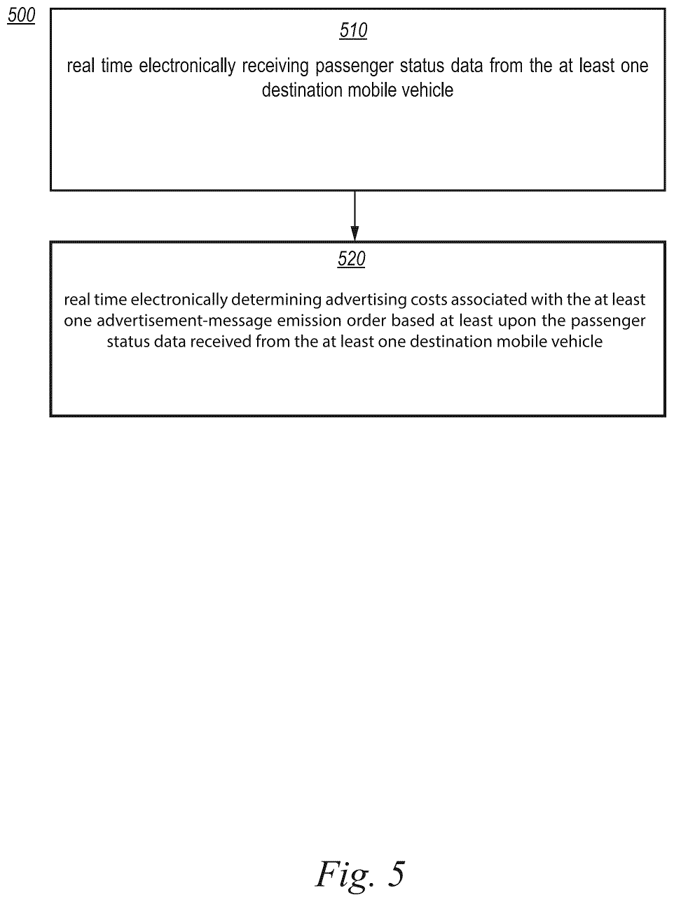

Turning to FIG. 5, depicted therein is a representative flow diagram associated with additional aspects of the real time vehicle coupled advertisement system 100 involving method 200 further including step 510 and step 520. Step 510 includes real time electronically receiving passenger status data from the at least one destination mobile vehicle. Step 520 includes real time electronically determining advertising costs associated with the at least one advertisement-message emission order based at least upon the passenger status data received from the at least one destination mobile vehicle.

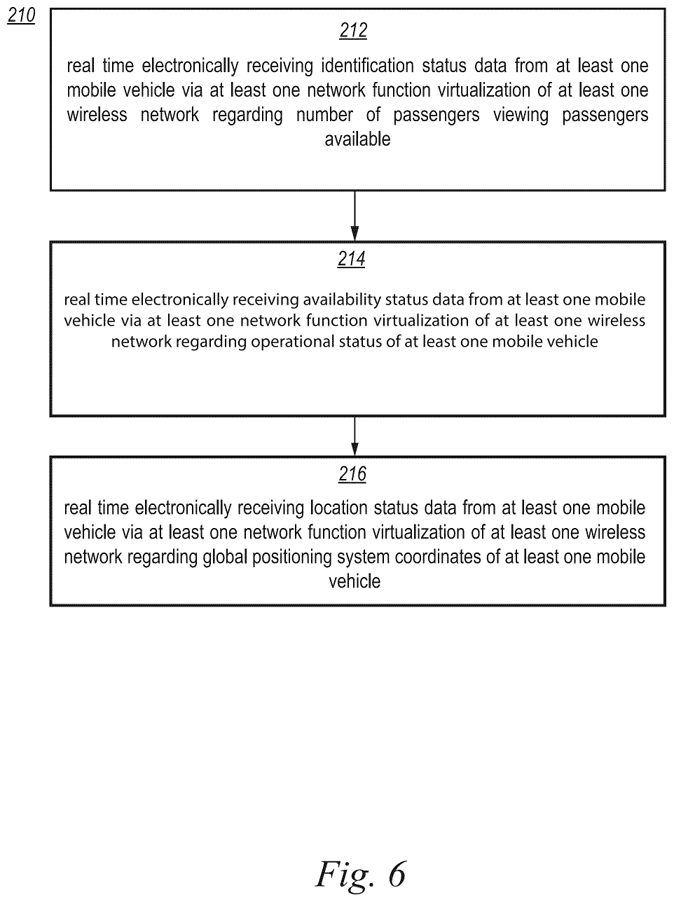

Turning to FIG. 6, depicted therein is a representative flow diagram associated with aspects of step 210 of method 200 including step 212, step 214, and step 216. Step 212 includes real time electronically receiving identification status data from at least one mobile vehicle via at least one network function virtualization of at least one wireless network regarding number of passengers viewing passengers available. Step 214 includes real time electronically receiving availability status data from at least one mobile vehicle via at least one network function virtualization of at least one wireless network regarding operational status of at least one mobile vehicle. Step 216 includes real time electronically receiving location status data from at least one mobile vehicle via at least one network function virtualization of at least one wireless network regarding global positioning system coordinates of at least one mobile vehicle.

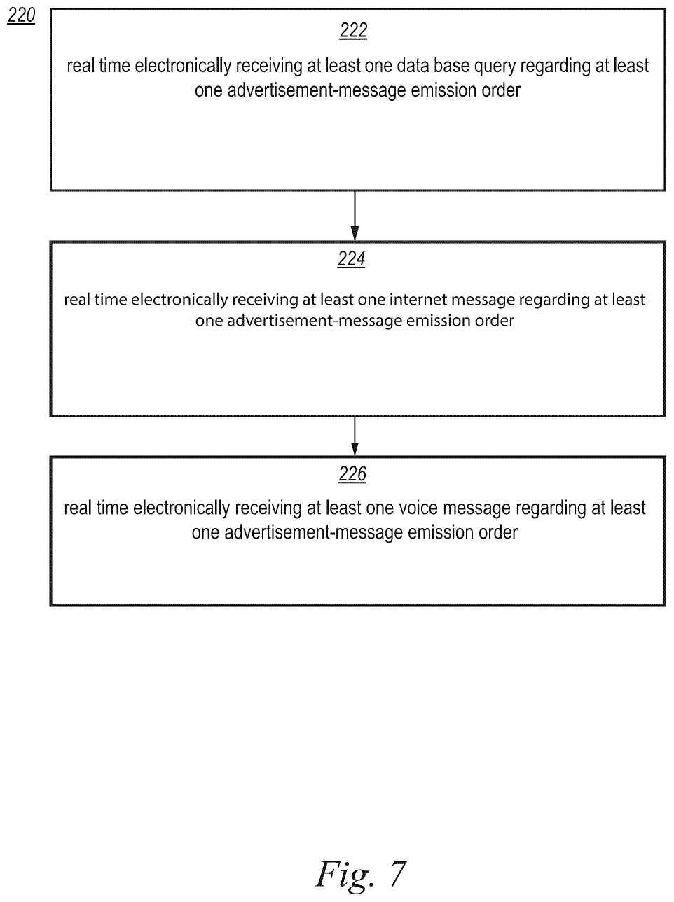

Turning to FIG. 7, depicted therein is a representative flow diagram associated with aspects of step 220 of method 200 including step 222, step 224, and step 226. Step 222 includes real time electronically receiving at least one data base query regarding at least one advertisement-message emission order. Step 224 includes real time electronically receiving at least one internet message regarding at least one advertisement-message emission order. Step 226 includes real time electronically receiving at least one voice message regarding at least one advertisement-message emission order.

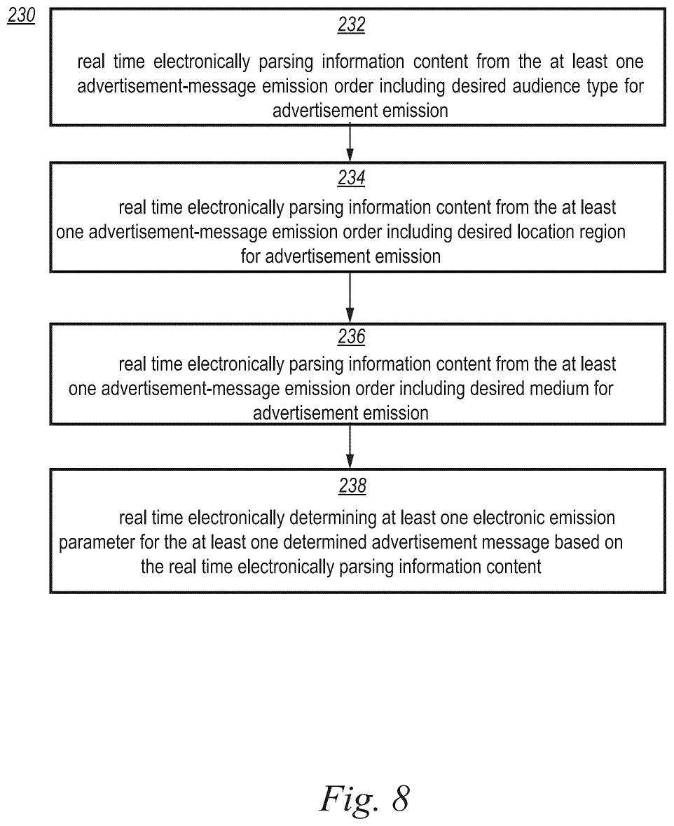

Turning to FIG. 8, depicted therein is a representative flow diagram associated with aspects of step 230 of method 200 including step 232, step 234, step 236, and step 238. Step 232 includes real time electronically parsing information content from the at least one advertisement-message emission order including desired audience type for advertisement emission. Step 234 includes real time electronically parsing information content from the at least one advertisement-message emission order including desired location region for advertisement emission. Step 236 includes real time electronically parsing information content from the at least one advertisement-message emission order including desired medium for advertisement emission. Step 238 includes real time electronically determining at least one electronic emission parameter for the at least one determined advertisement message based on the real time electronically parsing information content.

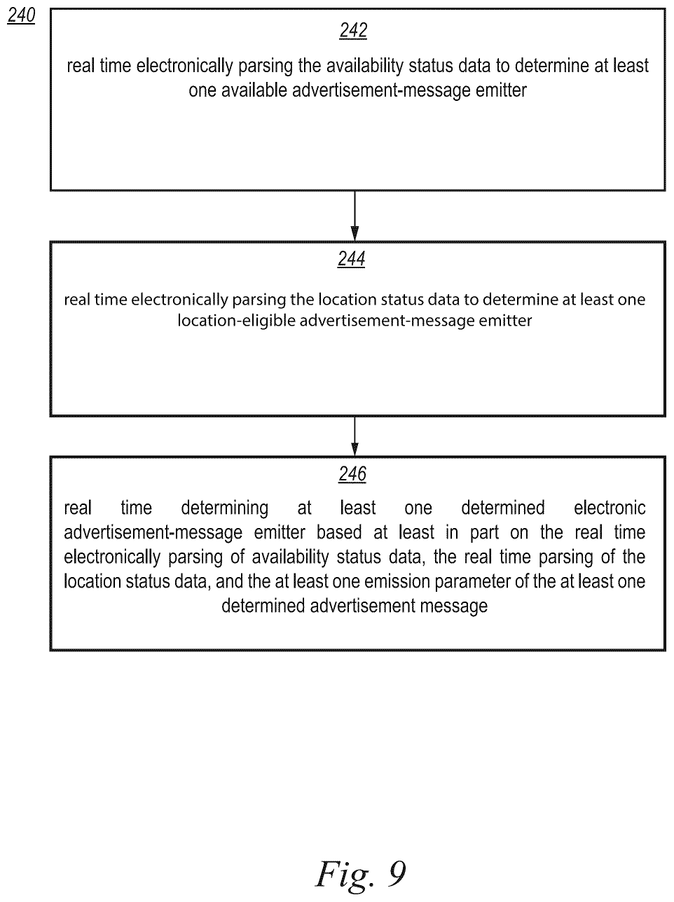

Turning to FIG. 9, depicted therein is a representative flow diagram associated with aspects of step 240 of method 200 including step 242, step 244, and step 246. Step 242 includes real time electronically parsing the availability status data to determine at least one available advertisement-message emitter. Step 244 includes real time electronically parsing the location status data to determine at least one location-eligible advertisement-message emitter. Step 246 includes real time determining at least one determined electronic advertisement-message emitter based at least in part on the real time electronically parsing of availability status data, the real time parsing of the location status data, and the at least one emission parameter of the at least one determined advertisement message.

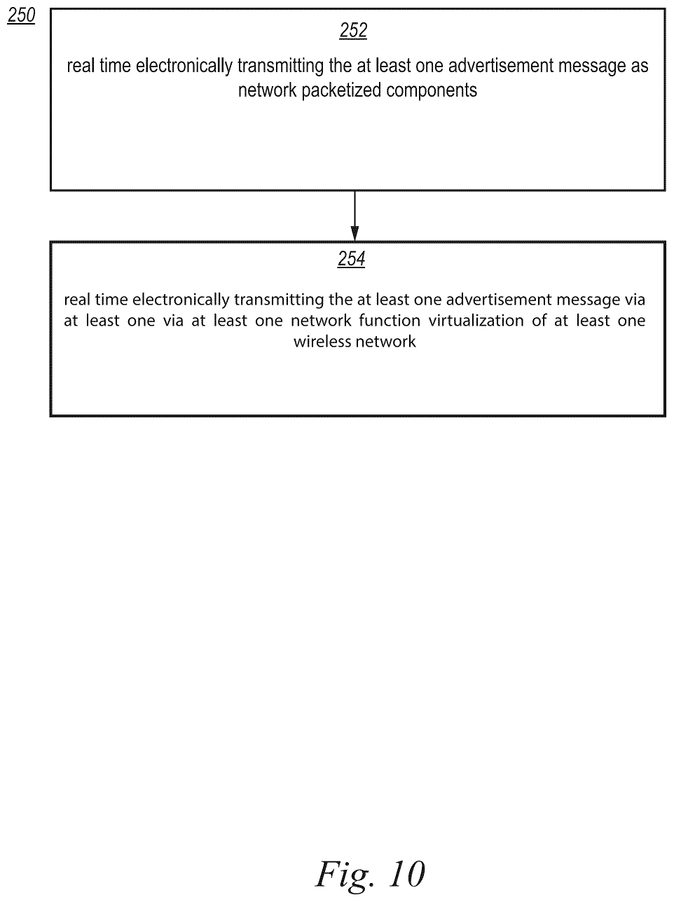

Turning to FIG. 10, depicted therein is a representative flow diagram associated with aspects of step 250 of method 200 including step 252, step 254, and step 256. Step 252 includes real time electronically transmitting the at least one advertisement message as network packetized components. Step 254 includes real time electronically transmitting the at least one advertisement message via at least one via at least one network function virtualization of at least one wireless network.

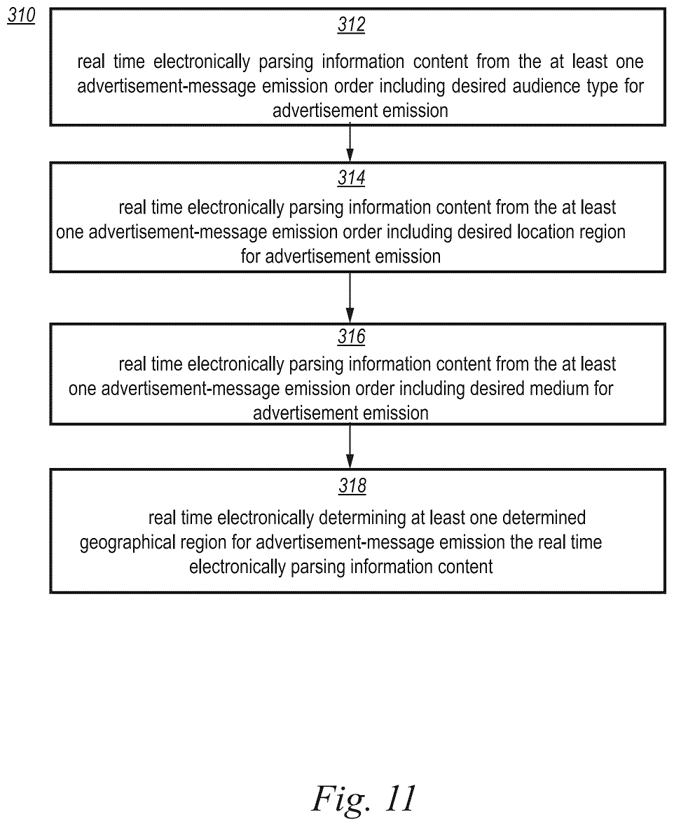

Turning to FIG. 11, depicted therein is a representative flow diagram associated with aspects of further step 310 of method 200 including step 312, step 314, step 316, and step 318. Step 312 includes real time electronically parsing information content from the at least one advertisement-message emission order including desired audience type for advertisement emission. Step 314 includes real time electronically parsing information content from the at least one advertisement-message emission order including desired location region for advertisement emission. Step 316 includes real time electronically parsing information content from the at least one advertisement-message emission order including desired medium for advertisement emission. Step 318 includes real time electronically determining at least one determined geographical region for advertisement-message emission the real time electronically parsing information content.

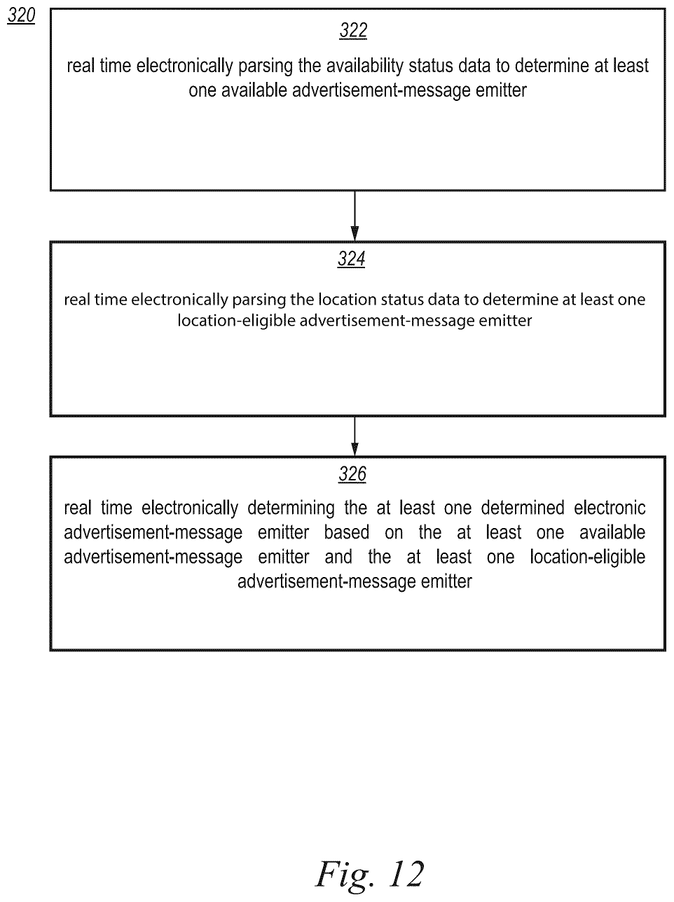

Turning to FIG. 12, depicted therein is a representative flow diagram associated with aspects of further step 320 of method 200 including step 322, step 324, and step 326. Step 322 includes real time electronically parsing the availability status data to determine at least one available advertisement-message emitter. Step 324 includes real time electronically parsing the location status data to determine at least one location-eligible advertisement-message emitter. Step 326 includes real time electronically determining the at least one determined electronic advertisement-message emitter based on the at least one available advertisement-message emitter and the at least one location-eligible advertisement-message emitter.

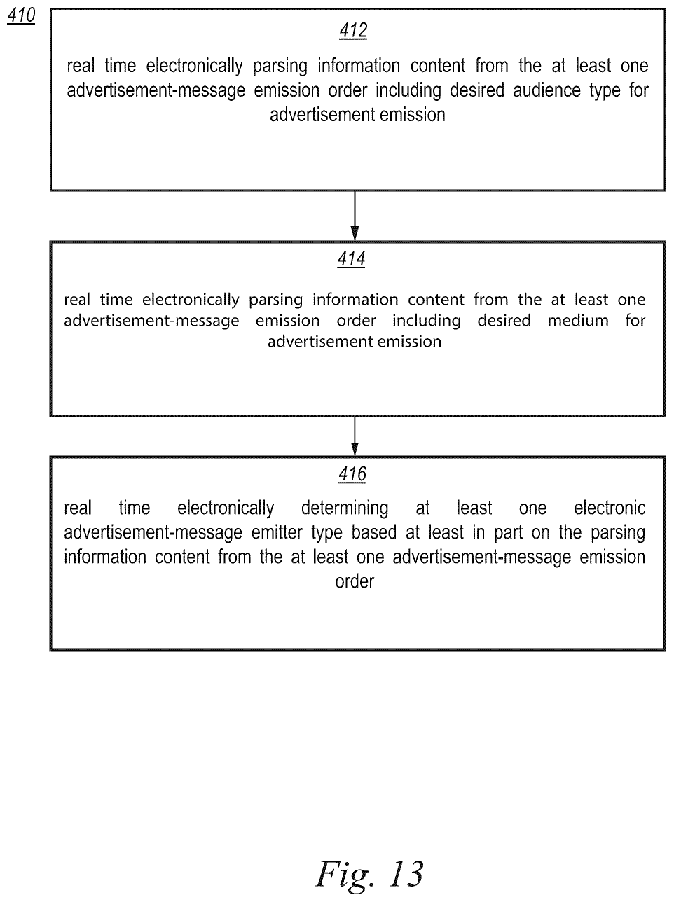

Turning to FIG. 13, depicted therein is a representative flow diagram associated with aspects of further step 410 of method 200 including step 412, step 414, and step 416. Step 412 includes real time electronically parsing information content from the at least one advertisement-message emission order including desired audience type for advertisement emission. Step 414 includes real time electronically parsing information content from the at least one advertisement-message emission order including desired medium for advertisement emission. Step 416 includes real time electronically determining at least one electronic advertisement-message emitter type based at least in part on the parsing information content from the at least one advertisement-message emission order.

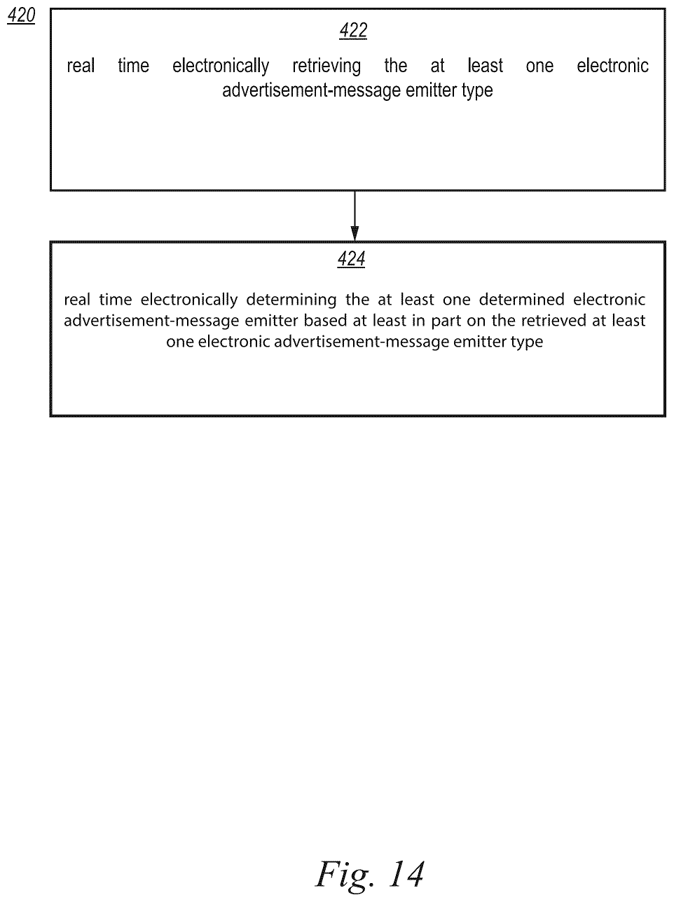

Turning to FIG. 14, depicted therein is a representative flow diagram associated with aspects of further step 420 of method 200 including step 422, and step 424. Step 422 includes real time electronically retrieving the at least one electronic advertisement-message emitter type. Step 424 includes real time electronically determining the at least one determined electronic advertisement-message emitter based at least in part on the retrieved at least one electronic advertisement-message emitter type.

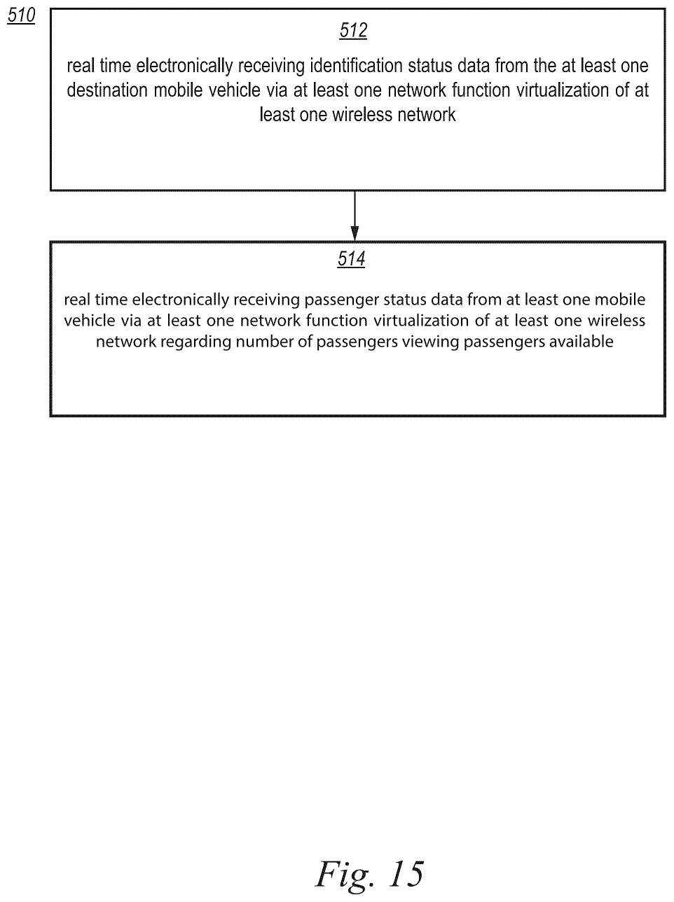

Turning to FIG. 15, depicted therein is a representative flow diagram associated with aspects of further step 510 of method 200 including step 512, and step 514. Step 512 includes real time electronically receiving identification status data from the at least one destination mobile vehicle via at least one network function virtualization of at least one wireless network. Step 514 includes real time electronically receiving passenger status data from at least one mobile vehicle via at least one network function virtualization of at least one wireless network regarding number of passengers viewing passengers available.

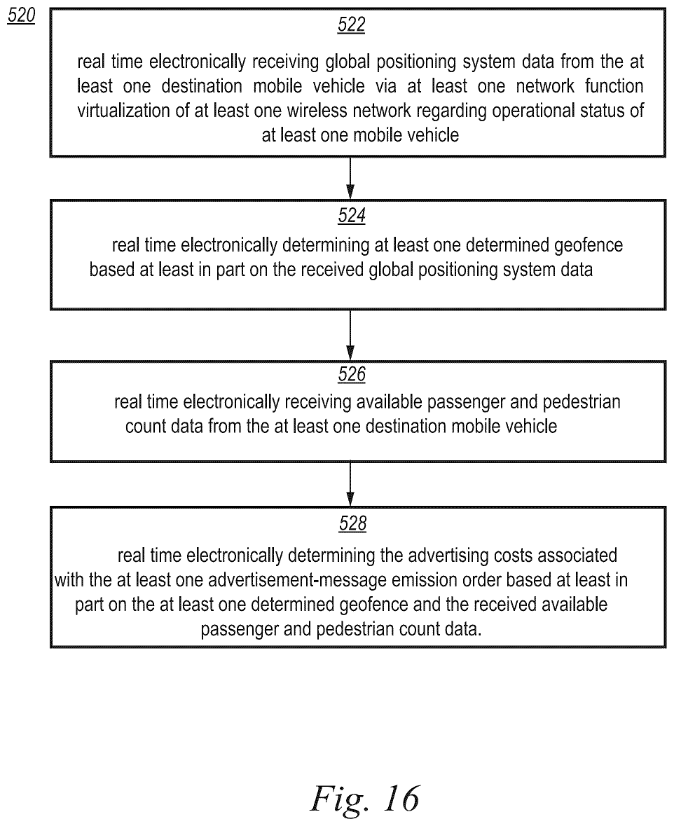

Turning to FIG. 16, depicted therein is a representative flow diagram associated with aspects of further step 520 of method 200 including step 522, step 524, step 526, and step 528. Step 522 includes real time electronically receiving global positioning system data from the at least one destination mobile vehicle via at least one network function virtualization of at least one wireless network regarding operational status of at least one mobile vehicle. Step 524 includes real time electronically determining at least one determined geofence based at least in part on the received global positioning system data. Step 526 includes real time electronically receiving available passenger and pedestrian count data from the at least one destination mobile vehicle. Step 528 includes real time electronically determining the advertising costs associated with the at least one advertisement-message emission order based at least in part on the at least one determined geofence and the received available passenger and pedestrian count data.

Although specific embodiments and examples of the disclosure have been described supra for illustrative purposes, various equivalent modifications can be made without departing from the spirit and scope of the disclosure, as will be recognized by those skilled in the relevant art after reviewing the present disclosure. The various embodiments described can be combined to provide further embodiments. The described devices, software, systems and methods can omit some elements or acts, can add other elements or acts, or can combine the elements or execute the acts in a different order than that illustrated, to achieve various advantages of the disclosure. These and other changes can be made to the disclosure in light of the above detailed description.

In general, in the following claims, the terms used should not be construed to limit the disclosure to the specific embodiments disclosed in the specification. Accordingly, the invention is not limited by the disclosure, but instead its scope is determined entirely by the following claims.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A computer implemented method of providing electronic real time advertisement message emission electronically emitted by one or more mobile vehicle coupled electronic advertisement message emitters according to reception of at least one order for at least one advertisement message emission, the computer implemented method comprising:
real time electronically receiving availability and location status data regarding at least one electronic advertisement message emitter being coupled with at least one mobile vehicle;
electronically receiving at least one advertisement message emission order for at least one advertisement message emission to be emitted by at least one electronic advertisement message emitter being coupled with at least one mobile vehicle;
real time determining at least one determined advertisement message to be emitted by at least one electronic advertisement message emitter coupled with at least one mobile vehicle based at least in part on the at least one advertisement message emission order;
real time determining at least one determined electronic advertisement message emitter coupled with at least one destination mobile vehicle to emit the at least one determined advertisement message based at least in part on the availability and location status data regarding the at least one determined electronic advertisement message emitter being coupled with at least one mobile vehicle; and
real time electronically transmitting the at least one advertisement message to the at least one destination mobile vehicle to be emitted by the determined electronic advertisement message emitter coupled with the at least one destination mobile vehicle.

2. The computer implemented method of claim 1 further including
real time electronically determining at least one determined geographical region for advertisement message emission associated with the at least one advertisement message emission order based at least in part on the at least one advertisement message emission order; and
real time electronically determining the at least one determined electronic advertisement message emitter coupled with the at least one destination mobile vehicle to emit the at least one determined advertisement message based at least in part on the at least one determined geographical region for advertisement message emission.

3. The computer implemented method of claim 1 further including
real time electronically determining at least one determined emitter type associated with the at least one determined electronic advertisement message emitter based at least in part on the at least one advertisement message emission order; and
real time electronically determining the at least one determined electronic advertisement message emitter coupled with the at least one destination mobile vehicle to emit the at least one determined advertisement message based at least in part on the at least one determined emitter type associated with the at least one determined electronic advertisement message emitter.

4. The computer implemented method of claim 1 further including
real time electronically receiving passenger status data from the at least one destination mobile vehicle; and
real time electronically determining advertising costs associated with the at least one advertisement message emission order based at least upon the passenger status data received from the at least one destination mobile vehicle.

5. The computer implemented method of claim 1
wherein the at least one determined electronic advertisement message emitter comprises at least one device selected from the group consisting of at least one electronic audio speaker, at least one electronic video display, at least one electronic alphanumeric text display, and at least one electronic audio video speaker display combination.

6. The computer implemented method of claim 1
wherein the at least one determined electronic advertisement message emitter comprises at least one emitter selected from the group consisting of: at least one emitter coupled to at least one subway vehicle exterior, at least one emitter coupled to at least one commuter train vehicle exterior, at least one emitter coupled to at least one bus vehicle exterior, at least one emitter coupled to at least one automobile vehicle exterior, at least one emitter coupled to at least one van vehicle exterior, and at least one emitter coupled to at least one truck vehicle exterior.

7. The computer implemented method of claim 1
wherein the at least one determined electronic advertisement message emitter comprises at least one emitter selected from the group consisting of: at least one emitter coupled to at least one subway vehicle interior, at least one emitter coupled to at least one commuter train vehicle interior, at least one emitter coupled to at least one bus vehicle interior, at least one emitter coupled to at least one automobile vehicle interior, at least one emitter coupled to at least one van vehicle interior, and at least one emitter coupled to at least one truck vehicle interior.

8. A real time electronic advertisement message emission system for providing real time electronic advertisement message emission electronically emitted by one or more mobile vehicle coupled electronic advertisement message emitters according to reception of at least one order for at least one advertisement message emission, the real time electronic advertisement message emission system comprising:
at least one memory; and
at least one processor configured for:
real time electronically receiving availability and location status data regarding at least one electronic advertisement message emitter being coupled with at least one mobile vehicle;
electronically receiving at least one advertisement message emission order for at least one advertisement message emission to be emitted by at least one electronic advertisement message emitter being coupled with at least one mobile vehicle;
real time determining at least one determined advertisement message to be emitted by at least one electronic advertisement message emitter coupled with at least one mobile vehicle based at least in part on the at least one advertisement message emission order;
real time determining at least one determined electronic advertisement message emitter coupled with at least one destination mobile vehicle to emit the at least one determined advertisement message based at least in part on the availability and location status data regarding the at least one determined electronic advertisement message emitter being coupled with at least one mobile vehicle; and
real time electronically transmitting the at least one advertisement message to the at least one destination mobile vehicle to be emitted by the determined electronic advertisement message emitter coupled with the at least one destination mobile vehicle.

9. The real time electronic advertisement message emission system of claim 8 wherein the at least one processor is further configured to:
real time electronically determining at least one determined geographical region for advertisement message emission associated with the at least one advertisement message emission order based at least in part on the at least one advertisement message emission order; and
real time electronically determining the at least one determined electronic advertisement message emitter coupled with the at least one destination mobile vehicle to emit the at least one determined advertisement message based at least in part on the at least one determined geographical region for advertisement message emission.

10. The real time electronic advertisement message emission system of claim 8 wherein the at least one processor is further configured to:
real time electronically determining at least one determined emitter type associated with the at least one determined electronic advertisement message emitter based at least in part on the at least one advertisement message emission order; and
real time electronically determining the at least one determined electronic advertisement message emitter coupled with the at least one destination mobile vehicle to emit the at least one determined advertisement message based at least in part on the at least one determined emitter type associated with the at least one determined electronic advertisement message emitter.

11. The real time electronic advertisement message emission system of claim 8 wherein the at least one processor is further configured to:
real time electronically receiving passenger status data from the at least one destination mobile vehicle; and
real time electronically determining advertising costs associated with the at least one advertisement message emission order based at least upon the passenger status data received from the at least one destination mobile vehicle.

12. The real time electronic advertisement message emission system of claim 8
wherein the at least one determined electronic advertisement message emitter comprises at least one device selected from the group consisting of at least one electronic audio speaker, at least one electronic video display, at least one electronic alphanumeric text display, and at least one electronic audio video speaker display combination.

13. The real time electronic advertisement message emission system of claim 8
wherein the at least one determined electronic advertisement message emitter comprises at least one emitter selected from the group consisting of: at least one emitter coupled to at least one subway vehicle, at least one emitter coupled to at least one commuter train vehicle, at least one emitter coupled to at least one bus vehicle, at least one emitter coupled to at least one automobile vehicle, at least one emitter coupled to at least one van vehicle, and at least one emitter coupled to at least one truck vehicle.

14. A non transitory computer readable medium comprising instruction for use on one or more electronic computing devices, the instructions being usable to execute a method of providing real time electronic advertisement message emission electronically emitted by one or more mobile vehicle coupled electronic advertisement message emitters according to reception of at least one order for at least one advertisement message emission, the method comprising:
real time electronically receiving equipment status monitoring sensor data from a plurality of electronic sensors based on one or more data types selected from a plurality of data types including but not limited to temperature data, magnetic flux data, vibration data, and ultrasound data;
real time electronically filtering of the equipment status monitoring sensor data to produce filtered equipment status monitoring sensor data with reduced noise content;
real time electronically determining at least in part one or more equipment status information based on one or more aspects of the filtered equipment status monitoring sensor data,
wherein the equipment status information includes one or more selections from a list including but not limited to one or more equipment status indicators, the equipment status monitoring sensor data, and the filtered equipment status monitoring sensor data, and one or more display instructions for use by the at least one subscriber based electronic user interface client application; and
real time electronically transmitting equipment status information to the at least one subscriber based electronic user interface client application based on at least one subscriber status associated with the at least one subscriber based electronic user interface client application.

15. The medium of claim 14 wherein the method comprises
real time electronically determining at least one determined geographical region for advertisement message emission associated with the at least one advertisement message emission order based at least in part on the at least one advertisement message emission order; and
real time electronically determining the at least one determined electronic advertisement message emitter coupled with the at least one destination mobile vehicle to emit the at least one determined advertisement message based at least in part on the at least one determined geographical region for advertisement message emission.

16. The medium of claim 14 wherein the method comprises
real time electronically determining at least one determined emitter type associated with the at least one determined electronic advertisement message emitter based at least in part on the at least one advertisement message emission order; and
real time electronically determining the at least one determined electronic advertisement message emitter coupled with the at least one destination mobile vehicle to emit the at least one determined advertisement message based at least in part on the at least one determined emitter type associated with the at least one determined electronic advertisement message emitter.

17. The medium of claim 14 wherein the method comprises
real time electronically receiving passenger status data from the at least one destination mobile vehicle; and
real time electronically determining advertising costs associated with the at least one advertisement message emission order based at least upon the passenger status data received from the at least one destination mobile vehicle.

18. The medium of claim 14 wherein the method comprises
the at least one determined electronic advertisement message emitter includes at least one device selected from the group consisting of at least one electronic audio speaker, at least one electronic video display, at least one electronic alphanumeric text display, and at least one electronic audio video speaker display combination.

19. The medium of claim 14 wherein the method comprises
the at least one determined electronic advertisement message emitter includes at least one emitter selected from the group consisting of: at least one emitter coupled to at least one subway vehicle exterior, at least one emitter coupled to at least one commuter train vehicle exterior, at least one emitter coupled to at least one bus vehicle exterior, at least one emitter coupled to at least one automobile vehicle exterior, at least one emitter coupled to at least one van vehicle exterior, and at least one emitter coupled to at least one truck vehicle exterior.

20. The medium of claim 14 wherein the method comprises
the at least one determined electronic advertisement message emitter includes at least one emitter selected from the group consisting of: at least one emitter coupled to at least one subway vehicle interior, at least one emitter coupled to at least one commuter train vehicle interior, at least one emitter coupled to at least one bus vehicle interior, at least one emitter coupled to at least one automobile vehicle interior, at least one emitter coupled to at least one van vehicle interior, and at least one emitter coupled to at least one truck vehicle interior.
